(19) United States
(12) Patent Application Publication
(10) Pub. No.: US 2014/0019449 A1
(43) Pub. Date: Jan. 16, 2014

(54) Method for Providing Codes for the State of Risk of a Battery

(71) Applicants: Samsung SDI Co., Ltd., Yongin-si (KR); Robert Bosch GmbH, Stuttgart (DE)

(72) Inventor: Frank Stimm, Stuttgart (DE)

(21) Appl. No.: 13/940,746

(22) Filed: Jul. 12, 2013

(30) Foreign Application Priority Data
Jul. 16, 2012 (DE) 10 2012 212 380.6

(51) Int. Cl. G06F 17/30

(52) U.S. Cl. CPC G06F 17/3061
USPC 707/736

(57) ABSTRACT

The present disclosure relates to a method for providing codes which describe the state of risk (SOR) of a battery having at least one cell. The method includes determining a code SORT for the state of risk of the battery with regard to the cell temperature, and determining a code SORV for the state of risk of the battery with respect to the cell voltage. The method further includes providing the code SORT and/or the code SORV for further use.

This application claims priority under 35 U.S.C. §119 to patent application no. DE 10 2012 212 380.6, filed on Jul. 16, 2012 in Germany, the disclosure of which is incorporated herein by reference in its entirety.

### BACKGROUND

The present disclosure relates to a method for providing codes which describe the state of risk (SOR) of a battery.

Batteries are usually used to supply energy to electrical components in motor vehicles, in particular electrical drives in electric and hybrid vehicles. Lithium ion batteries are preferably used nowadays.

These batteries have a non-negligible risk potential as a result of their design and chemistry. If operating limits are exceeded, the result may be a battery fire or escape of hazardous chemical substances from the battery.

One cause of such a risk situation may be, for example, an excessively high charging current in the battery, which current exists for an excessively long period or at an excessively high frequency, for example at low temperatures. This may result in so-called “lithium plating”, a state in which lithium ions collect on the anode of the battery. This may result in the growth of a dendrite which may subsequently be able to damage and possibly pierce the separator of the battery. Consequently, the result may be an internal short circuit in the battery. If such an internal short circuit is present, the result is a thermal reaction, a so-called “thermal runaway”, in which the battery may be heated and a fire or even an explosion may be finally triggered.

In order to enable the fastest possible fault analysis and assessment of devices and apparatuses, different codes have been developed which describe the state of a relevant device or an apparatus.

In the field of batteries, the code SOH (“state of health”) is customary, for example. This code is used as a measure of the ageing state of a battery and is determined using the input variables of loss of capacitance and increase in the internal resistance.

However, a considerable risk potential may also come from a battery. There may thus be a risk of explosion in a battery, in particular a lithium ion battery, which is in a so-called “thermal runaway”.

Against this background, a possibility for quickly estimating the risk from a battery is expedient. It is thus desirable, for example when replacing defective batteries or when maintaining batteries, to be able to reliably estimate the risk from the battery in the instantaneous state without the need to carry out lengthy diagnostic methods.

No code which describes the state of risk of a battery has hitherto been known.

### SUMMARY

The method according to the disclosure for providing codes which describe the state of risk (SOR) of a battery in principle comprises the following steps of:
determining a code SORT for the state of risk of the battery with regard to the cell temperature, SORT being determined, by means of an evaluation function, taking into account the input variables of instantaneous cell temperature Tₐₖₜ for one, more or all cells of the battery, number #T_{hoch} of events in which at least one cell temperature has exceeded a predefined threshold value and the instantaneous rate of cell temperature change ΔT(t) for one, more or all cells of the battery; and/or
determining a code SORV for the state of risk of the battery with respect to the cell voltage, SORV being determined, by means of an evaluation function, taking into account the input variables of the battery voltage U_{Bat} and cell voltage U_{Zell} for one, more or all cells of the battery; and
providing the codes SORT and SORV for further use.

### DETAILED DESCRIPTION

In the method according to the disclosure, parameters and information from the history and the instantaneous state of the battery are used to be combined to form simple codes. Two types of codes may be ascertained in this case, the code SORT (“state of risk for thermal impact”) for the state of risk of the battery with regard to the cell temperature and the code SORV (“state of risk for voltage impact”) for the state of risk of the battery with regard to the cell voltage. Each of these codes individually, and when the two codes SORT and SORV are combined, makes it possible to quickly determine whether a battery is in a safe state, and these codes may contribute to quickly changing a battery to a safe state. In the method according to the disclosure, suitable individual diagnoses are combined for this purpose in order to form a risk value for the battery temperature, SORT, and/or a risk value for the battery voltage, SORV, therefrom. These two codes are substantially used to describe and monitor all parameters which provide reliable indications of an existing risk situation with regard to the relevant battery.

In order to ensure that the state of risk of a battery is estimated in a particularly reliable manner, both codes, SORT and SORV, are preferably determined in the method according to the disclosure.

For the purposes of the present disclosure, a battery is understood as meaning a functional arrangement which comprises one or a plurality of battery modules and/or battery cells. In this case, each battery module has one or more battery cells which are respectively combined to form a functional unit. The plurality of battery modules or battery cells of a battery may be connected in a suitable manner. For this purpose, the individual battery modules or battery cells of the battery may be connected to one another in an electrically conductive manner in such a way that they are arranged to form desired battery module or battery system architectures.

In this case, a battery cell is understood as meaning an electrochemical energy store which can store energy by means of electrochemical processes and can provide said energy again if required. In principle, battery modules having battery cells of any rechargeable battery or battery cell type may be used in the battery of the vehicle electrical system according to the disclosure. The battery preferably comprises battery cells of the lithium ion cell type, in particular of the lithium ion (Li-ion) rechargeable battery type, of the lithium polymer (LiPo) rechargeable battery type, of the lithium metal (LiFe) rechargeable battery type, of the lithium manganese (LiMn) rechargeable battery type, of the lithium iron phosphate (LiFePO₄) rechargeable battery type, and of the lithium titanate (LiTi) rechargeable battery type.

The battery in the method according to the disclosure is preferably a lithium ion battery, in particular a high-capacity lithium ion battery, particularly preferably a battery, for example a lithium ion battery, having a nominal capacity of ≧2 Ah, preferably ≧3 Ah.

The battery in the method according to the disclosure may have a battery management system (BMS). A battery management system is understood as meaning an electronic circuit which monitors and controls, in particular, the operation as well as the charging and discharging process of the battery. In addition, the BMS may be in the form of an interface between the battery and its electronic components and the environment. In this case, the BMS may be assigned different functions, for example charging control of the battery or battery cells, load management, cell balancing and temperature management. In order to be able to perform these functions, data relating to particular parameters of the battery or battery cells are continuously supplied to the BMS. Such data generally comprise data relating to the temperature of the battery or battery cells, data relating to the voltage of the battery or battery cells, data relating to the battery current etc. These data are acquired by the BMS and stored in a memory. These data may be read from the memory of the BMS in the method according to the disclosure and may be used as input variables for determining the codes SORT and/or SORV. The state of risk of a battery can therefore be determined in a fast and efficient manner, by means of the method according to the disclosure, using the available data from the BMS in the form of the codes SORT and SORV and can be provided for further use.

In the method according to the disclosure, the code SORT can be determined for the state of risk of the battery with regard to the temperature. The instantaneous temperature Tₐₖₜ for one, more or all cells of the battery is used as the input variable for determining SORT. This input variable can be used to determine whether at least one battery cell has already currently left the temperature range for safe operation of the battery.

In addition, the number #T_{hoch} of events in which the cell temperature has exceeded a predefined threshold value for at least one battery cell is additionally used as the input variable for determining SORT. In this case, the threshold value is preferably selected in such a manner that, if the threshold value is exceeded, there is an increased probability of lasting damage occurring in the cell. This input variable can be used to determine whether damage or impairment must already be assumed for a cell of the battery.

The instantaneous rate of temperature change ΔT(t) for one, more or all cells of the battery is used as the third input variable for determining SORT. This input variable describes the change in the temperature of a cell of the battery on the basis of time. If the temperature of a battery cell per unit of time increases to a particularly great extent, the probability of this cell changing to a “thermal runaway” or already being in a “thermal runaway” is increased. This input variable can therefore be used to determine whether an increased risk directly and specifically comes from this cell.

In addition, yet further input variables may be used when determining SORT. It is thus known that the discharge of a battery or battery cell beyond a particular threshold value, a so-called deep discharge, can damage the battery just like overcharging of the battery or a battery cell. The increase in the pressure in the battery or in a battery cell may also be an indication of an increased risk situation from the battery. Another indicator of the presence of damage in a battery is the evolution and/or release of gas from one, more or all cells of the battery. One preferred embodiment of the method according to the disclosure is distinguished by the fact that the input variables of number of deep discharges of one, more or all cells of the battery, overcharging of one, more or all cells of the battery, cell pressure of one, more or all cells of the battery and/or the evolution of gas in one, more or all cells of the battery are additionally taken into account when determining SORT.

In the method according to the disclosure, the code SORV may be determined for the state of risk of the battery with regard to the voltage. The battery voltage U_{Bat} and the cell voltage U_{Zell} for one, more or all cells of the battery are used as the input variable for determining SORV. If one, more or all of these input variables respectively exceed(s) or undershoot(s) a threshold value, damage to the battery and thus an increased risk situation from the battery must be assumed.

Yet further input variables may additionally be used when determining SORV. Important information relating to the state of risk of the battery may thus likewise be derived from the instantaneous insulation resistance Rᵢₛₒ and from the instantaneous battery current I_{Bat}. It is additionally possible to determine whether there is a so-called “contactor adhesive”. The number of detected blown fuses may also be taken into account. One preferred embodiment of the method according to the disclosure is distinguished by the fact that the input variables of link voltage Uₗᵢₙₖ, instantaneous insulation resistance Rᵢₛₒ, battery current I_{Bat} and/or the number of detected blown fuses of the battery are additionally taken into account when determining SORV.

An evaluation function is used to determine, from the corresponding input variables, the code SORT for the state of risk of the battery with regard to the cell temperature and/or the code SORV for the state of risk of the battery with regard to the cell voltage. The actual configuration of the evaluation function depends on the battery to be monitored and a person skilled in the art can determine this for the specific application without unreasonable effort. In particular, in the method according to the disclosure, provision may be made for the evaluation functions for determining the codes SORT and/or SORV to comprise the determination of the code using a fault tree, a truth table and/or an algorithm. In this case, the different input variables can be included in the determination with a suitable weighting. The codes SORT and SORV can each be stated in the form of a discrete value. Different possibilities are conceivable in this case. For example, each code may assume only two values, for example 0 for safe and 1 for possibly dangerous. Alternatively, however, it is also possible to use a scale of values having a plurality of graduations for the actual risk situation, for example an assessment on a scale from 0 to 10. It is also possible for the codes SORT and SORV to each be in the form of a fault code which allows external software to indicate the faults.

In the method according to the disclosure, the determined codes SORT and/or SORV are provided for further use. Such a further use may involve visually indicating the codes. Such an indication may be effected, for example, using a display; in a simple refinement, the risk situation may also be effected, on the basis of the code, by means of a simple visual signal, for example a warning light. Alternatively or additionally, the risk situation may be acoustically indicated. For example, provision may be made to output a warning signal if a code indicates the presence of an actual risk from the battery. The codes SORT and/or SORV may also be provided, however, in such a manner that they can be transmitted to an external or on-board diagnostic system and possibly used there to further assess the risk situation.

The present disclosure also relates to a computer program which makes it possible for a data processing device to carry out a method according to the disclosure after the program has been loaded into memory means of the data processing device.

The disclosure is also directed to a computer-readable storage medium which stores a program which makes it possible for a data processing device to carry out a method according to the disclosure after the program has been loaded into memory means of the data processing device.

The present disclosure also relates to a method in which the abovementioned computer program is downloaded from an electronic data network, for example from the Internet, onto a data processing device connected to the data network.

What is claimed is:

1. A method for providing codes configured to describe a state of risk of a battery having at least one cell, the method comprising:
determining a code SORT for the state of risk of the battery with regard to a cell temperature of the at least one cell, the code SORT being determined by a first evaluation function configured to take into account a first plurality of input variables including (i) an instantaneous cell temperature for the at least one cell, (ii) a number of events in which the instantaneous cell temperature has exceeded a predefined threshold value, and (iii) an instantaneous rate of cell temperature change of the at least one cell;
determining a code SORV for the state of risk of the battery with respect to a cell voltage of the at least one cell, the code SORV being determined by a second evaluation function configured to take into account a second plurality of input variables including (i) a battery voltage, and (ii) the cell voltage of the at least one cell; and
providing at least one of the code SORT and the code SORV for further use.

2. The method according to claim 1, wherein the first plurality of input variables further includes at least one of (i) a number of deep discharges of at least one cell, (ii) an overcharging of the at least one cell, (iii) a cell pressure of the at least one cell, and (iv) an evolution of gas in the at least one cell.

3. The method according to claim 1, wherein the second plurality of input variables further includes at least one of (i) a link voltage, (ii) an instantaneous insulation resistance, (iii) a battery current, and (iv) a number of detected blown fuses of the battery.

4. The method according to claim 1, wherein at least one of the first evaluation function and the second evaluation function includes using at least one of a fault tree, a truth table, and an algorithm.

5. The method according to claim 4, wherein variables of the first plurality of variables and variables of the second plurality of variables are used with different weightings.

6. The method according to claim 1, further comprising:
reading the first plurality of variables and the second plurality of variables from a memory of a battery management system of the battery.

7. The method according to claim 1, further comprising:
providing the code SORT and the code SORV for an on-board diagnostic system.

8. The method according to claim 1, wherein a computer program is configured to enable a data processing device to carry out the method after the computer program has been loaded into a memory device of the data processing device.

9. The method according to claim 8, wherein:
the computer program is downloaded from an electronic data network onto the data processing device connected to the data network, and
the electronic data network is the Internet.

10. A computer-readable storage medium of a data processing device comprising:
a memory device configured to store a program for enabling the data processing device to carry out a method after the program has been loaded into the memory device,
wherein the method is for providing codes configured to describe a state of risk of a battery having at least one cell,
wherein the method includes
determining a code SORT for the state of risk of the battery with regard to a cell temperature of the at least one cell, the code SORT being determined by a first evaluation function configured to take into account a first plurality of input variables including (i) an instantaneous cell temperature for the at least one cell, (ii) a number of events in which the instantaneous cell temperature has exceeded a predefined threshold value, and (iii) an instantaneous rate of cell temperature change of the at least one cell,
determining a code SORV for the state of risk of the battery with respect to a cell voltage of the at least one cell, the code SORV being determined by a second evaluation function configured to take into account a second plurality of input variables including (i) a battery voltage, and (ii) the cell voltage of the at least one cell, and
providing at least one of the code SORT and the code SORV for further use.
